(19) United States
(12) Patent Application Publication
(10) Pub. No.: US 2004/0193884 A1
(43) Pub. Date: Sep. 30, 2004

(54) Secure watchdog for embedded systems

(75) Inventors: Donald Molaro, Sunnyvale, CA (US); Ted Dunn, Los Gatos, CA (US)

Correspondence Address: Jonathan O. Owens, HAVERSTOCK & OWENS LLP, 162 North Wolfe Road, Sunnyvale, CA, 94086, US

(73) Assignees: Sony Corporation; Sony Electronics Inc.

(21) Appl. No.: 10/402,167

(22) Filed: Mar. 26, 2003

(51) Int. Cl. G06F 11/30

(52) U.S. Cl. 713/175

(57) ABSTRACT

A watchdog controller securely interrogates a main system CPU of an application module to determine if the main system CPU and its associated programming software are trustworthy. The watchdog controller and the application module preferably reside within a set top box. The watchdog controller includes a watchdog CPU which generates a digitally signed status request message using a watchdog certificate. The status request message is received by the main system CPU and validated for authenticity. The main system CPU then generates a status response message using a system certificate. The status response message is received by the watchdog processor and validated for authenticity. If the status response message is not valid then the watchdog controller preferably triggers a system reset. After the system is reset, a similar attempt is made to receive a valid status response message from the main system CPU. If the status response message is again not valid, then the watchdog CPU triggers the launching of a retrieval software program. The retrieval software accesses a remote content source to download a trusted version of a software stack used to operate the set top box. The trusted version of the software stack replaces a current version of the software stack stored in memory of the application module.

### FIELD OF THE INVENTION

The present invention relates to the field of embedded systems. More particularly, the present invention relates to the field of a secondary processor used to interrogate a main system central processing unit as to the health of the system.

### BACKGROUND OF THE INVENTION

It is an objective of device manufacturers to provide devices which are only used in the manner in which they were originally intended. For example, in the case where an electronic device is a set top box, the set top box is intended to only allow the display of content for which a consumer is authorized to view. However, in conventional set top boxes, the software stack used to operate the set top box is often “hacked” to allow unauthorized viewing of content. Content providers are increasingly demanding that electronic devices are secure such that only authorized users can view the content. It is therefore desired to validate that the programming software that operates an electronic device is authentic, and to replace any programming software that is determined to be invalid.

### SUMMARY OF THE INVENTION

Embodiments of the present invention include a watchdog controller and an application module, where the watchdog controller securely interrogates a main system CPU of the application module to determine if the main system CPU and its associated programming software are trustworthy. The watchdog controller and the application module preferably reside within the same device. The device is preferably a set top box. The watchdog controller includes a watchdog CPU which generates a digitally signed status request message using a watchdog certificate. The status request message is received by the main system CPU and validated for authenticity. The main system CPU then generates a status response message using a system certificate. The status response message is received by the watchdog processor and validated for authenticity; If the status response message is not valid then the watchdog controller preferably triggers a system reset. After the system is reset, a similar attempt is made to receive a valid status response message from the main system CPU. If the status response message is again not valid, then the watchdog CPU triggers the launching of a retrieval software program. The retrieval software accesses a remote content source to download a trusted version of a software stack used to operate the set top box. The trusted version of the software stack replaces a current version of the software stack stored in memory of the application module.

In one aspect of the present invention, a method of maintaining valid processing functionality includes forming a secure status request message by a first processor, wherein the status request message is signed using a digital certificate of the first processor, sending the secure status request message to a second processor, validating an authenticity of the status request message by the second processor, forming a secure status response message by the second processor if the status request message is valid, wherein the status response message is signed using a digital certificate of the second processor, sending the secure status response message to the first processor and validating an authenticity of the status response message by the first processor. The status response message can indicate that an operating software associated with the second processor is functioning correctly. The status response message can indicate that an application software associated with the second processor is functioning correctly. The status response message can indicate that a software stack associated with the second processor is functioning correctly. If the status response message is not valid, the method can also include resetting the second processor, and performing the steps of forming a secure status request, sending the status request message, validating the status request message, forming a secure status response message, sending the status response message, and validating the status response message. If the status response message is not valid, the method can also include retrieving a trusted version of a software stack for the second processor, and replacing a current version of the software stack on the second processor with the trusted version of the software stack. Retrieving the trusted version of the software stack can comprise accessing a remote content source and downloading the trusted version of the software stack from the remote content source. The method can also include activating a retrieval program, wherein the retrieval program performs the process of accessing the remote content source and downloading the trusted version of the software stack. The remote content source can be accessed via the Internet. If the status response message is not valid, the method can include retrieving a trusted version of a software stack for the second processor, replacing a current version of the software stack on the second processor with the trusted version of the software stack, resetting the second processor, and performing the steps of forming a secure status request, sending the status request message, validating the status request message, forming a secure status response message, sending the status response message, and validating the status response message.

In another aspect of the present invention, a device to maintain valid processing functionality includes a watchdog controller including a first processor, and an application module including a second processor, wherein the application module is coupled to the watchdog controller such that in operation the first processor generates a secure status request message, wherein the status request message is signed using a digital certificate of the first processor, the first processor sends the secure status request message to a second processor, the second processor validates an authenticity of the status request message, the second processor generates a secure status response message if the status request message is valid, wherein the status response message is signed using a digital certificate of the second processor, the second processor sends the secure status response message to the first processor, and the first processor validates an authenticity of the status response message. The first processor can comprise an embedded processor within the watchdog controller. The digital certificate of the first processor can be an embedded certificate from the first processor. The digital certificate of the second processor can be an embedded certificate from the second processor. The digital certificate of the first processor can be stored within a trusted area of the watchdog controller, and the digital certificate of the second processor is stored within a trusted area of the application module. The watchdog controller can comprise a board micro controller. The second processor can comprise a main system central processing unit (CPU). The device can comprise a consumer electronic device. The device can comprise a set top box. The application module can further comprise a secondary memory to store a software stack used to operate the device. The status response message from the second processor can indicate that the software stack is functioning correctly. The application module can further comprise an input/output (I/O) interface to couple the device to a remote content source such that if the status response message is not valid, then the application module retrieves a trusted version of a software stack from the remote content source and replaces a current version of the software stack in the secondary memory of the application module with the trusted version of the software stack. The secondary memory of the application module can include a retrieval program which is used to perform the process of retrieving the trusted version of the software stack from the remote content source and replacing the current version of the software stack in the secondary memory with the trusted version of the software stack. The retrieval program can be stored within a trusted area of the secondary memory. The I/O interface can be coupled to the remote content source via the Internet. If the status response message is not valid, then the application module can be reset.

In yet another aspect of the present invention, a set top box to maintain valid processing functionality includes a watchdog controller including a first processor, and an application module including a second processor, wherein the application module is coupled to the watchdog controller such that in operation the first processor generates a secure status request message, wherein the status request message is signed using a digital certificate of the first processor, the first processor sends the secure status request message to a second processor, the second processor validates an authenticity of the status request message, the second processor generates a secure status response message if the status request message is valid, wherein the status response message is signed using a digital certificate of the second processor, the second processor sends the secure status response message to the first processor, and the first processor validates an authenticity of the status response message. The first processor can comprise an embedded processor within the watchdog controller. The digital certificate of the first processor can be an embedded certificate from the first processor. The digital certificate of the second processor can be an embedded certificate from the second processor. The digital certificate of the first processor can be stored within a trusted area of the watchdog controller, and the digital certificate of the second processor is stored within a trusted area of the application module. The watchdog controller can comprise a board micro controller. The second processor can comprise a main system central processing unit (CPU). The device can comprise a consumer electronic device. The device can comprise a set top box. The application module can further comprise a secondary memory to store a software stack used to operate the device. The status response message from the second processor can indicate that the software stack is functioning correctly. The application module can further comprise an input/output (I/O) interface to couple the set top box to a remote content source such that if the status response message is not valid, then the application module retrieves a trusted version of a software stack from the remote content source and replaces a current version of the software stack in the secondary memory of the application module with the trusted version of the software stack. The secondary memory of the application module can include a retrieval program which is used to perform the process of retrieving the trusted version of the software stack from the remote content source and replacing the current version of the software stack in the secondary memory with the trusted version of the software stack. The retrieval program can be stored within a trusted area of the secondary memory. The I/O interface can be coupled to the remote content source via the Internet. If the status response message is not valid, then the application module can be reset.

In yet another aspect of the present invention, a network of devices to maintain valid processing functionality includes a remote content source, a watchdog controller coupled to the remote content source, wherein the watchdog controller comprises a first processor, and an application module including a second processor, wherein the application module is coupled to the watchdog controller such that in operation the first processor generates a secure status request message, wherein the status request message is signed using a digital certificate of the first processor, the first processor sends the secure status request message to a second processor, the second processor validates an authenticity of the status request message, the second processor generates a secure status response message if the status request message is valid, wherein the status response message is signed using a digital certificate of the second processor, the second processor sends the secure status response message to the first processor, and the first processor validates an authenticity of the status response message. The first processor can comprise an embedded processor within the watchdog controller. The digital certificate of the first processor can be an embedded certificate from the first processor. The digital certificate of the second processor can be an embedded certificate from the second processor. The digital certificate of the first processor can be stored within a trusted area of the watchdog controller, and the digital certificate of the second processor is stored within a trusted area of the application module. The watchdog controller can comprise a board micro controller. The second processor can comprise a main system central processing unit (CPU). The watchdog controller and the application module can comprise a single device. The single device can comprise a set top box. The application module can further comprise a secondary memory to store a software stack used to operate the device. The status response message from the second processor can indicate that the software stack is functioning correctly. The application module can further comprise an input/output (I/O) interface to couple the application module to the remote content source such that if the status response message is not valid, then the application module retrieves a trusted version of a software stack from the remote content source and replaces a current version of the software stack in the secondary memory of the application module with the trusted version of the software stack. The secondary memory of the application module can include a retrieval program which is used to perform the process of retrieving the trusted version of the software stack from the remote content source and replacing the current version of the software stack in the secondary memory with the trusted version of the software stack. The retrieval program can be stored within a trusted area of the secondary memory. The I/O interface can be coupled to the remote content source via the Internet. If the status response message is not valid, then the application module can be reset.

### BRIEF DESCRIPTION OF THE DRAWINGS

FIG. 1 illustrates an exemplary network of devices.

FIG. 2 illustrates a block diagram of an exemplary set top box according to the present invention.

FIGS. 3A and 3B illustrate a process of validating the authenticity of a software stack and replacing an invalid software stack according to the preferred embodiment of the present invention.

### DETAILED DESCRIPTION OF THE EMBODIMENTS

Embodiments of the present invention validate a trustworthiness of an electronic device, and if the electronic device is found to be untrustworthy, a process is defined by which the electronic device is made trustworthy. The electronic device is preferably a set top box. The set top box includes a watchdog controller and an application module. The application module includes a main system CPU and a system memory. The application module also includes a system certificate associated with the main system CPU, where the system certificate is used to digitally sign control messages and requests sent by the main system CPU. The system certificate is stored in a trusted area of the application module, preferably within a trusted area of the system memory. The watchdog controller preferably includes an embedded watchdog CPU and memory. The watchdog controller also includes a watchdog certificate associated with the watchdog CPU, where the watchdog certificate is used to digitally sign messages sent by the watchdog CPU.

The watchdog controller initiates a cryptographically secure interrogation of the main system CPU to determine if the main system CPU and its associated programming software are trustworthy. The secure interrogation is performed by the watchdog CPU first generating a secure status request message. The status request message comprises a message digitally signed using the watchdog certificate. The status request message is then sent to the main system CPU. The main system CPU validates the status request message by verifying the authenticity of the digital signature of the status request message. In response to receiving a valid status request message, the main system CPU generates a secure status response message, digitally signed using the system certificate, and sends the status response message to the watchdog CPU. The watchdog CPU validates the status response message by verifying the authenticity of the digital signature of the status response message. A valid status response message indicates that the main system CPU and associated programming software are trustworthy and are therefore operating as intended.

If it is determined that the status response message is not valid, then the watchdog controller initiates a process to correct the problem. Preferably, a first attempt to solve the problem is made by the watchdog controller triggering a reset of the set top box. Once the set top box is reset, the same cryptographically secure interrogation as described above is performed to determine if the main system CPU and associated programming software are trustworthy. If a valid status response message is received, then no further problem solving is performed. However, if again the status response message is not valid, then a second attempt to solve the problem is made by the watch dog controller. The second attempt starts by the watchdog controller triggering a launch of a retrieval software program from the system memory. The retrieval program then accesses a remote content source, downloads a trusted version of a software stack from the remote content source, and replaces a current version of the software stack in system memory with the trusted version. Preferably, the system reset is then triggered by the watchdog controller and the cryptographically secure interrogation is again performed.

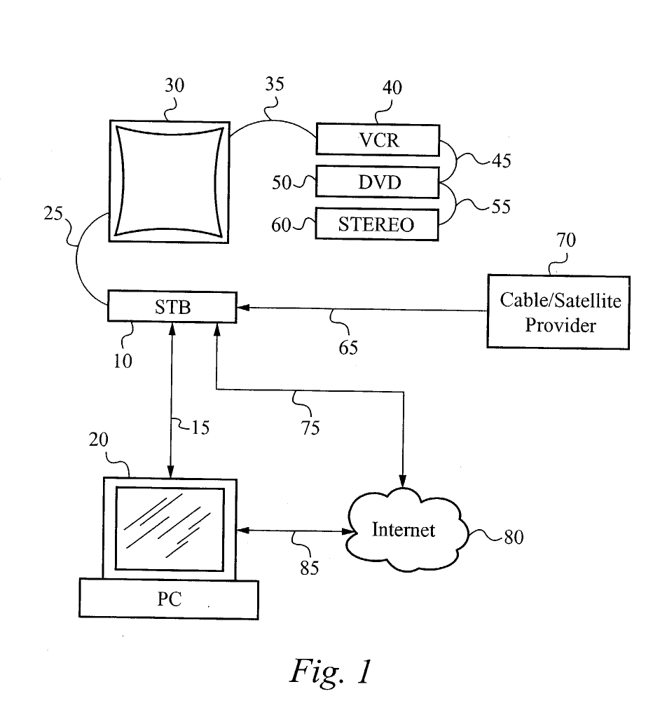

FIG. 1 illustrates an exemplary network of devices including a stereo receiver 60, a DVD player 50, a video cassette recorder (VCR) 40, a set top box (STB) 10, a television 30, a computer 20, a cable/satellite provider 70 and the Internet 80 connected together by network connections 15, 25, 35, 45, 55, 65, 75, and 85. The network connection 55 couples the stereo receiver 60 to the DVD player 50. The network connection 45 couples the DVD player 50 to the VCR 40. The network connection 35 couples the VCR 40 to the television 30. The network connection 25 couples the television 30 to the STB 10. The network connection 15 couples the STB 10 to the PC 20. The network connection 65 couples the STB 10 to the cable/satellite provider 70. The network connection 75 couples the STB 10 to the Internet 80. The network connection 85 couples the PC 20 to the Internet 80.

The configuration illustrated in FIG. 1 is exemplary only. It should be apparent that an audio/video network could include many different combinations of components. It should also be apparent that network connections 15, 25, 35, 45 and 55 can be of any conventional type, including but not limited to ethernet, IEEE 1394-2000, or wireless. Network connections 65, 75 and 85 can be of any conventional type sufficient to provide a connection to a remote content source, including but not limited to the public switched telephone network, cable network, and satellite network.

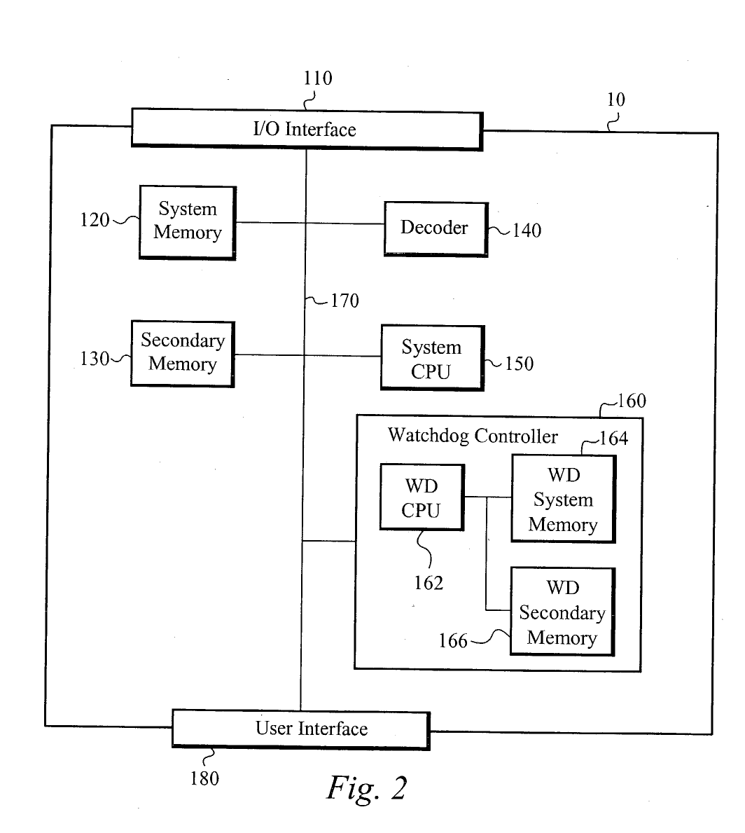

FIG. 2 illustrates an exemplary set top box 10 according to the present invention. The set top box 10 preferably controls the transmission of audio/video signals from a remote content provider, such as the cable/satellite provider 70 (FIG. 1) to a display, or from local storage device, such as the personal computer (PC) 20 (FIG. 1), to a display. The set top box 10 includes an input/output (I/O) interface 110, a system memory 120, a secondary memory 130, a decoder 140, a system central processing unit (CPU) 150, a watchdog controller 160, and a user interface 180 all coupled via a bi-directional bus 170. The I/O interface 110 preferably couples the set top box 10 to a content source, such as the cable/satellite provider 70 (FIG. 1) or the PC 20 (FIG. 1), for receiving audio/video signals. The I/O interface 110 can also be coupled to a conventional network, such as the Internet 80 (FIG. 1), to download periodic software upgrades including new versions of operating software and new or upgraded applications, or to download replacement software as will be discussed in greater detail below. The I/O interface 110 also sends and receives control signals to and from the user interface 180 and the television 30 (FIG. 1), the PC 20 (FIG. 1) and remote computing devices coupled to the conventional network. The user interface 180 preferably comprises a keypad and display, as is well known in the art. Alternatively, the user interface 180 comprises any conventional user interface.

The secondary memory 130 stores the software used to enable operation of the set top box 10 along with a plurality of applications. Exemplary applications include, but are not limited to a menu of available content such as an on-screen television guide, and display parameter settings such as color, tint, and brightness. A certificate associated with the system CPU 150 is preferably stored in the secondary memory 130. The certificate associated with the system CPU 150 is used to digitally sign outgoing messages from the system CPU 150. Preferably, the secondary memory 130 comprises flash memory. Alternatively, any conventional type of memory can be used. Preferably, the system memory 140 includes random access memory (RAM). The system memory 140 can also include additional buffers, registers, and cache according to specific design implementations. Audio/video signals received by the set top box 10 are preferably encrypted to prevent unauthorized access and use, and the decoder 140 decrypts the audio/video signal according to access authorization provided by the system CPU 150.

The watchdog controller 160 includes a watchdog CPU 162, a watchdog system memory 164, and a watchdog secondary memory 166. The watchdog controller 160 is preferably a board micro controller and the watchdog CPU 162 is preferably an embedded CPU. The watchdog controller 160 includes a certificate associated with the watchdog CPU 162 and the certificate is used to digitally sign outgoing control messages. The certificate of the watchdog controller 160 is preferably an embedded certificate and is stored in a trusted area of the watchdog controller 160. Preferably, the watchdog system memory 164 comprises RAM and the watchdog secondary memory 166 comprises flash memory.

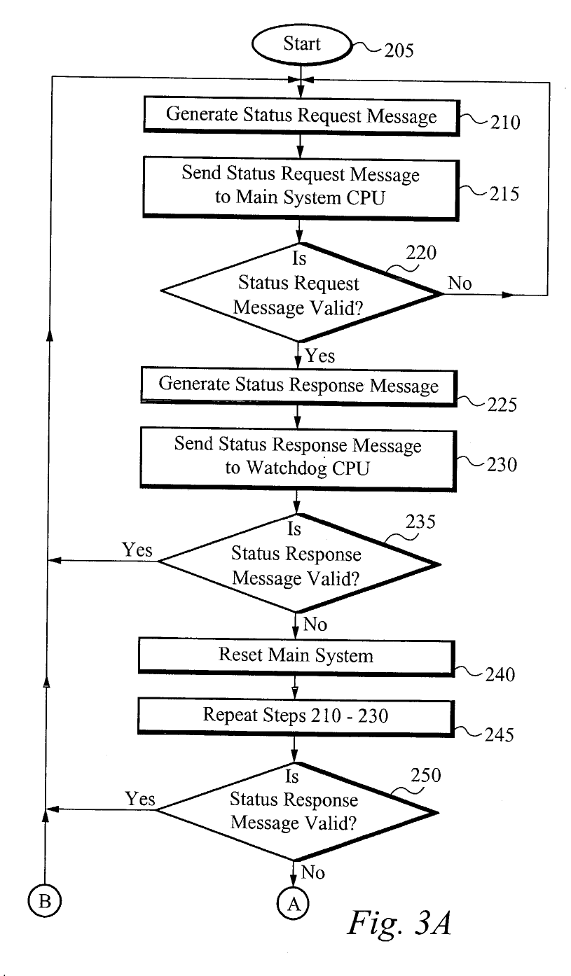

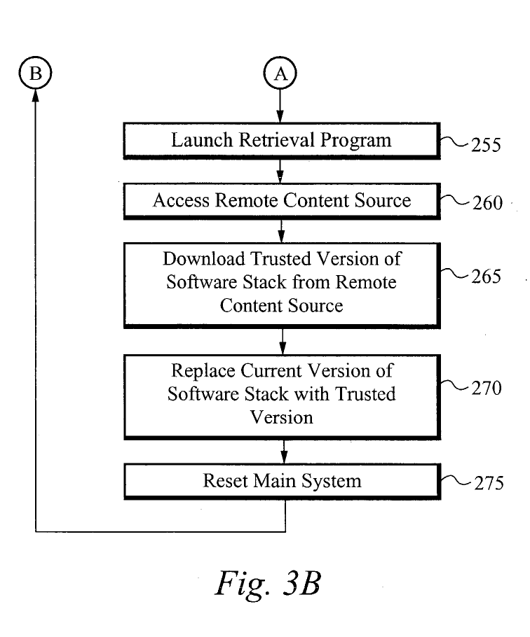

FIGS. 3A and 3B illustrate a process of validating the authenticity of a software stack within the set top box 10 of FIG. 2, and replacing an invalid software stack according to the preferred embodiment of the present invention. The process starts at the step 205. At the step 210, the watchdog CPU 162 (FIG. 2) generates a status request message. The status request message is also referred to as an “identify friend or foe” (IFF) message. The status request message is digitally signed using a watchdog certificate associated with the watchdog CPU 162. Preferably, the watchdog certificate is stored in a trusted area of the watchdog controller 160 (FIG. 2). At the step 215, the status request message is sent to the main system CPU 150 (FIG. 2). At the step 220, it is determined by the main system CPU 150 if the status request message is valid. The validity of the status request message is determined by verifying the authenticity of the digital signature associated with the status request message. If it is determined that the status request message is not valid at the step 220, then the process jumps to the step 210. If it is determined that the status request message is valid at the step 220, then at the step 225 the main system CPU 150 generates a status response message. The status response message is digitally signed using a system certificate associated with the main system CPU 150. Preferably, the system certificate is stored in a trusted area coupled to the main system CPU 150. At the step 230, the status response message is sent to the watchdog CPU 162. At the step 235, it is determined by the watchdog CPU 162 if the status response message is valid. The validity of the status response message is determined by verifying the authenticity of the digital signature associated with the status response message.

If it is determined that the status response message is valid at the step 235, then the process jumps to the step 210. If it is determined that the status response message is not valid at the step 235, then at the step 240 the watchdog CPU 162 triggers a system reset, or in other words, the set top box 10 is reset. Once the set top box 10 is reset at the step 240, then at the step 245, the steps 210 through 230 are performed so that the watchdog CPU 162 receives another status response message from the main system CPU 150. At the step 250, it is determined if the status response message received at the step 245 is valid. If it is determined that the status response message is valid at the step 250, then the process jumps to the step 210. If it is determined that the status request message is not valid at the step 220, then at the step 255, the watchdog CPU 162 triggers the launch of a retrieval program from the secondary memory 130. The retrieval program is a trusted software program, preferably stored in a trusted area of the secondary memory 130. At the step 260, the retrieval program accesses a remote content source. Preferably, the set top box 10 is coupled to the remote content source via the Internet 80 (FIG. 1). Upon accessing the remote content source, at the step 265 a trusted version of a software stack is downloaded from the remote content source to the set top box 10. At the step 270, the trusted version of the software stack replaces a current version of the software stack stored in the secondary memory 130 of the set top box 10. At the step 275, the system reset is triggered. Once the set top box 10 is reset at the step 275, the process jumps to the step 210.

In operation, a device, preferably a set top box, includes a watchdog controller and an application module, where the watchdog controller securely interrogates a main system CPU of the application module to determine if the main system CPU and its associated programming software are trustworthy. The watchdog controller includes a watchdog CPU which generates a digitally signed status request message using a watchdog certificate. The watchdog certificate is preferably stored in a trusted area of the watchdog controller. The status request message is received by the main system CPU and validated for authenticity. Once validated, the main system CPU generates a status response message using a system certificate, the system certificate is preferably stored in a trusted area of the system. The status response message is received by the watchdog processor and validated for authenticity. If the status response message is not valid then the watchdog controller preferably triggers a system reset. After the system is reset, a similar attempt is made to receive a valid status response message from the main system CPU. If the status response message is again not valid, then the watchdog CPU triggers the launching of a retrieval software program. The retrieval program is preferably stored in a trusted area of system memory. The retrieval software accesses a remote content source to download a trusted version of a software stack used to operate the set top box. The trusted version of the software stack replaces a current version of the software stack stored in memory of the application module. In this manner, if the set top box is “hacked” and the programming software is altered or replaced with an unauthorized version, the set top box can replace the unauthorized software with a trusted, authorized version.

Although it is preferred that the watchdog controller and the application module reside within the same device, the watchdog controller and the application module can alternatively each reside within a separate device coupled to each other.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill in the art that while the preferred embodiment of the present invention is used with set-top boxes, the present invention can also be implemented on any other appropriate system resource limited device.

What is claimed is:

1. A method of maintaining valid processing functionality, the method comprising:
a. forming a secure status request message by a first processor, wherein the status request message is signed using a digital certificate of the first processor;
b. sending the secure status request message to a second processor;
c. validating an authenticity of the status request message by the second processor;
d. forming a secure status response message by the second processor if the status request message is valid, wherein the status response message is signed using a digital certificate of the second processor;
e. sending the secure status response message to the first processor; and
f. validating an authenticity of the status response message by the first processor.

2. The method of claim 1 wherein the status response message indicates that an operating software associated with the second processor is functioning correctly.

3. The method of claim 1 wherein the status response message indicates that an application software associated with the second processor is functioning correctly.

4. The method of claim 1 wherein the status response message indicates that a software stack associated with the second processor is functioning correctly.

5. The method of claim 1 wherein if the status response message is not valid, the method further comprises:
g. resetting the second processor; and
h. performing a-f above.

6. The method of claim 5 wherein if the status response message is not valid, the method further comprises:
i. retrieving a trusted version of a software stack for the second processor; and
j. replacing a current version of the software stack on the second processor with the trusted version of the software stack.

7. The method of claim 6 wherein retrieving the trusted version of the software stack comprises accessing a remote content source and downloading the trusted version of the software stack from the remote content source.

8. The method of claim 7 further comprising activating a retrieval program, wherein the retrieval program performs the process of accessing the remote content source and downloading the trusted version of the software stack.

9. The method of claim 7 wherein the remote content source is accessed via the Internet.

10. The method of claim 1 wherein if the status response message is not valid, the method further comprises:
g. retrieving a trusted version of a software stack for the second processor;
h. replacing a current version of the software stack on the second processor with the trusted version of the software stack;
i. resetting the second processor; and
j. performing a-f above.

11. A device to maintain valid processing functionality, the device comprising:
a. a watchdog controller including a first processor; and
b. an application module including a second processor, wherein the application module is coupled to the watchdog controller such that in operation the first processor generates a secure status request message, wherein the status request message is signed using a digital certificate of the first processor, the first processor sends the secure status request message to a second processor, the second processor validates an authenticity of the status request message, the second processor generates a secure status response message if the status request message is valid, wherein the status response message is signed using a digital certificate of the second processor, the second processor sends the secure status response message to the first processor, and the first processor validates an authenticity of the status response message.

12. The device of claim 11 wherein the first processor comprises an embedded processor within the watchdog controller.

13. The device of claim 11 wherein the digital certificate of the first processor is an embedded certificate from the first processor.

14. The device of claim 11 wherein the digital certificate of the second processor is an embedded certificate from the second processor.

15. The device of claim 11 wherein the digital certificate of the first processor is stored within a trusted area of the watchdog controller, and the digital certificate of the second processor is stored within a trusted area of the application module.

16. The device of claim 11 wherein the watchdog controller comprises a board micro controller.

17. The device of claim 11 wherein the second processor comprises a main system central processing unit (CPU).

18. The device of claim 11 wherein the device comprises a consumer electronic device.

19. The device of claim 11 wherein the device comprises a set top box.

20. The device of claim 11 wherein the application module further comprises a secondary memory to store a software stack used to operate the device.

21. The device of claim 20 wherein the status response message from the second processor indicates that the software stack is functioning correctly.

22. The device of claim 20 wherein the application module further comprises an input/output (I/O) interface to couple the device to a remote content source such that if the status response message is not valid, then the application module retrieves a trusted version of a software stack from the remote content source and replaces a current version of the software stack in the secondary memory of the application module with the trusted version of the software stack.

23. The device of claim 22 wherein the secondary memory of the application module includes a retrieval program which is used to perform the process of retrieving the trusted version of the software stack from the remote content source and replacing the current version of the software stack in the secondary memory with the trusted version of the software stack.

24. The device of claim 23 wherein the retrieval program is stored within a trusted area of the secondary memory.

25. The device of claim 22 wherein the I/O interface is coupled to the remote content source via the Internet.

26. The device of claim 11 wherein if the status response message is not valid, then the application module is reset.

27. A set top box to maintain valid processing functionality, the device comprising:
a. a watchdog controller including a first processor; and
b. an application module including a second processor, wherein the application module is coupled to the watchdog controller such that in operation the first processor generates a secure status request message, wherein the status request message is signed using a digital certificate of the first processor, the first processor sends the secure status request message to a second processor, the second processor validates an authenticity of the status request message, the second processor generates a secure status response message if the status request message is valid, wherein the status response message is signed using a digital certificate of the second processor, the second processor sends the secure status response message to the first processor, and the first processor validates an authenticity of the status response message.

28. The set top box of claim 27 wherein the first processor comprises an embedded processor within the watchdog controller.

29. The set top box of claim 27 wherein the digital certificate of the first processor is an embedded certificate from the first processor.

30. The set top box of claim 27 wherein the digital certificate of the second processor is an embedded certificate from the second processor.

31. The set top box of claim 27 wherein the digital certificate of the first processor is stored within a trusted area of the watchdog controller, and the digital certificate of the second processor is stored within a trusted area of the application module.

32. The set top box of claim 27 wherein the watchdog controller comprises a board micro controller.

33. The set top box of claim 27 wherein the second processor comprises a main system central processing unit (CPU).

34. The set top box of claim 27 wherein the device comprises a consumer electronic device.

35. The set top box of claim 27 wherein the device comprises a set top box.

36. The set top box of claim 27 wherein the application module further comprises a secondary memory to store a software stack used to operate the device.

37. The set top box of claim 36 wherein the status response message from the second processor indicates that the software stack is functioning correctly.

38. The set top box of claim 36 wherein the application module further comprises an input/output (I/O) interface to couple the set top box to a remote content source such that if the status response message is not valid, then the application module retrieves a trusted version of a software stack from the remote content source and replaces a current version of the software stack in the secondary memory of the application module with the trusted version of the software stack.

39. The set top box of claim 38 wherein the secondary memory of the application module includes a retrieval program which is used to perform the process of retrieving the trusted version of the software stack from the remote content source and replacing the current version of the software stack in the secondary memory with the trusted version of the software stack.

40. The set top box of claim 39 wherein the retrieval program is stored within a trusted area of the secondary memory.

41. The set top box of claim 38 wherein the I/O interface is coupled to the remote content source via the Internet.

42. The set top box of claim 27 wherein if the status response message is not valid, then the application module is reset.

43. A network of devices to maintain valid processing functionality, the network of devices comprising:
a. a remote content source;
b. a watchdog controller coupled to the remote content source, wherein the watchdog controller comprises a first processor; and
c. an application module including a second processor, wherein the application module is coupled to the watchdog controller such that in operation the first processor generates a secure status request message, wherein the status request message is signed using a digital certificate of the first processor, the first processor sends the secure status request message to a second processor, the second processor validates an authenticity of the status request message, the second processor generates a secure status response message if the status request message is valid, wherein the status response message is signed using a digital certificate of the second processor, the second processor sends the secure status response message to the first processor, and the first processor validates an authenticity of the status response message.

44. The network of devices of claim 43 wherein the first processor comprises an embedded processor within the watchdog controller.

45. The network of devices of claim 43 wherein the digital certificate of the first processor is an embedded certificate from the first processor.

46. The network of devices of claim 43 wherein the digital certificate of the second processor is an embedded certificate from the second processor.

47. The network of devices of claim 43 wherein the digital certificate of the first processor is stored within a trusted area of the watchdog controller, and the digital certificate of the second processor is stored within a trusted area of the application module.

48. The network of devices of claim 43 wherein the watchdog controller comprises a board micro controller.

49. The network of devices of claim 43 wherein the second processor comprises a main system central processing unit (CPU).

50. The network of devices of claim 43 wherein the watchdog controller and the application module comprise a single device.

51. The network of devices of claim 50 wherein the single device comprises a set top box.

52. The network of devices of claim 43 wherein the application module further comprises a secondary memory to store a software stack used to operate the device.

53. The network of devices of claim 52 wherein the status response message from the second processor indicates that the software stack is functioning correctly.

54. The network of devices of claim 52 wherein the application module further comprises an input/output (I/O) interface to couple the application module to the remote content source such that if the status response message is not valid, then the application module retrieves a trusted version of a software stack from the remote content source and replaces a current version of the software stack in the secondary memory of the application module with the trusted version of the software stack.

55. The network of devices of claim 54 wherein the secondary memory of the application module includes a retrieval program which is used to perform the process of retrieving the trusted version of the software stack from the remote content source and replacing the current version of the software stack in the secondary memory with the trusted version of the software stack.

56. The network of devices of claim 55 wherein the retrieval program is stored within a trusted area of the secondary memory.

57. The network of devices of claim 54 wherein the I/O interface is coupled to the remote content source via the Internet.

58. The network of devices of claim 43 wherein if the status response message is not valid, then the application module is reset.

59. An apparatus to maintain valid processing functionality, the apparatus comprising:
a. means for forming a secure status request message by a first processor, wherein the status request message is signed using a digital certificate of the first processor;
b. means for sending the secure status request message to a second processor;
c. means for validating an authenticity of the status request message by the second processor;
d. means for forming a secure status response message by the second processor if the status request message is valid, wherein the status response message is signed using a digital certificate of the second processor;
e. means for sending the secure status response message to the first processor; and
f. means for validating an authenticity of the status response message by the first processor.

60. The apparatus of claim 59 wherein the status response message indicates that an operating software associated with the second processor is functioning correctly.

61. The apparatus of claim 59 wherein the status response message indicates that an application software associated with the second processor is functioning correctly.

62. The apparatus of claim 59 wherein the status response message indicates that a software stack associated with the second processor is functioning correctly.

63. The apparatus of claim 59 further comprising means for resetting the second processor if the status response message is not valid.

64. The apparatus of claim 59 further comprising:
i. means for retrieving a trusted version of a software stack for the second processor if the status response message is not valid; and
j. means for replacing a current version of the software stack on the second processor with the trusted version of the software stack.

65. The apparatus of claim 64 wherein the means for retrieving the trusted version of the software stack comprises means for accessing a remote content source and means for downloading the trusted version of the software stack from the remote content source.

66. The apparatus of claim 65 further comprising means for activating a retrieval program, wherein the retrieval program performs the process of accessing the remote content source and downloading the trusted version of the software stack.

67. The apparatus of claim 65 wherein the remote content source is accessed via the Internet.

68. The apparatus of claim 59 wherein the first processor is included within a board micro controller.

69. The apparatus of claim 59 wherein the second processor is included within a main system. central processing unit (CPU).

70. The apparatus of claim 59 wherein the device comprises a consumer electronic device.

71. The apparatus of claim 59 wherein the device comprises a set top box.
